(19) United States
(12) Patent Application Publication
(10) Pub. No.: US 2026/0177993 A1
(43) Pub. Date: Jun. 25, 2026

(54) MANAGING THREE-DIMENSIONAL PRINTERS USING AN ARTIFICIAL INTELLIGENCE ENABLED DECISION ENGINE

(71) Applicant: INTERNATIONAL BUSINESS MACHINES CORPORATION, Armonk, NY (US)

(72) Inventors: Martin G. Keen, Cary, NC (US); Jeremy R. Fox, Georgetown, TX (US); Sarbajit Kumar Rakshit, Kolkata (IN); Carolina Garcia Delgado, Zapopan (MX)

(21) Appl. No.: 18/999,371

(22) Filed: Dec. 23, 2024

(51) Int. Cl. G05B 13/02; B29C 64/118; B29C 64/386; B33Y 50/00

(52) U.S. Cl. CPC G05B 13/0265; B29C 64/118; B29C 64/386; B33Y 50/00

(57) ABSTRACT

Systems and methods are provided for managing 3D printers using an artificial intelligence enabled decision engine. Data from a network of sensors can be collected to obtain external factors and internal factors that affect a 3D printer. An artificial intelligence-enabled decision engine (AIDE) that determines an effect of the external factors and the internal factors while printing a target 3D object can be trained using feedback and collected data. Optimal commands for the 3D printer that minimizes the effect of external factors and the internal factors while printing a target 3D object can be generated using the AIDE. The optimal commands for the 3D printer can be performed using a 3D printing execution module while printing the target 3D object to compensate for the external factors and the internal factors.

### BACKGROUND

The present invention generally relates to managing three-dimension (3D) printing, and more particularly to managing 3D printers using an artificial intelligence enabled decision engine.

Three dimensional (3D) printing, also known as additive manufacturing, has revolutionized the way objects are designed and created. It allows for the fabrication of complex geometries layer by layer, from digital blueprints.

### SUMMARY

In accordance with an embodiment of the present invention, a computer-implemented method is provided, including, collecting data from a network of sensors to obtain external factors and internal factors that affect a 3D printer, training an artificial intelligence-enabled decision engine (AIDE) that determines an effect of external factors and the internal factors while printing a target 3D object using feedback and collected data, generating, using the AIDE, optimal commands for the 3D printer that minimizes an effect of external factors and the internal factors while printing a target 3D object, and performing the optimal commands for the 3D printer using a 3D printing execution module while printing the target 3D object to compensate for the external factors and internal factors.

In accordance with another embodiment of the present invention, a computer system is provided including, a processor set, one or more computer-readable storage media, and program instructions stored on the one or more computer-readable storage media to cause the processor set to perform operations having, collecting data from a network of sensors to obtain external factors and internal factors that affect a 3D printer, training an artificial intelligence-enabled decision engine (AIDE) that determines an effect of external factors and the internal factors while printing a target 3D object using feedback and collected data, generating, using the AIDE, optimal commands for the 3D printer that minimizes an effect of external factors and the internal factors while printing a target 3D object, and performing the optimal commands for the 3D printer using a 3D printing execution module while printing the target 3D object to compensate for the external factors and internal factors.

In accordance with yet another embodiment of the present invention, a computer program product is provided including one or more computer-readable storage media, and program instructions stored on the one or more computer-readable storage media to perform operations further including collecting data from a network of sensors to obtain external factors and internal factors that affect a 3D printer, training an artificial intelligence-enabled decision engine (AIDE) that determines an effect of external factors and the internal factors while printing a target 3D object using feedback and collected data, generating, using the AIDE, optimal commands for the 3D printer that minimizes an effect of external factors and the internal factors while printing a target 3D object, and performing the optimal commands for the 3D printer using a 3D printing execution module while printing the target 3D object to compensate for the external factors and internal factors.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a flow diagram showing a high-level overview of a computer-implemented method of managing 3D printers, in accordance with an embodiment of the present invention;

FIG. 2 is a block showing a computing system for managing 3D printers, in accordance with an embodiment of the present invention;

FIG. 3 is a block diagram showing a 3D printing system, in accordance with an embodiment of the present invention;

FIG. 4 is a block diagram showing a system that manages 3D printers using the AI-enabled decision engine, in accordance with an embodiment of the present invention; and

FIG. 5 is a block diagram showing the operations employed to generate optimal commands, in accordance with an embodiment of the present invention.

### DETAILED DESCRIPTION

In accordance with embodiments of the present invention, systems and methods are provided for managing 3D printers using an artificial intelligence enabled decision engine. The present embodiments can minimize the effects of internal factors (e.g., nozzle height, material temperature, microstructure of a target object, etc.) and external factors (e.g., airflow, temperature, humidity) to the printing process of a 3D printer by using an artificial intelligence enabled decision engine that generates optimal commands to compensate for the internal and external factors.

With the present embodiments, data from a network of sensors can be collected to obtain external factors and internal factors that affect a 3D printer. An artificial intelligence-enabled decision engine (AIDE) that determines an effect of the external factors and the internal factors while printing a target 3D object can be trained using feedback and collected data. Optimal commands for the 3D printer that minimizes the effect of external factors and the internal factors while printing a target 3D object can be generated using the AIDE. The optimal commands for the 3D printer can be performed using a 3D printing execution module while printing the target 3D object to compensate for the external factors and the internal factors.

Three dimensional (3D) printing, also known as additive manufacturing, has revolutionized the way objects are designed and created. 3D printing allows for the fabrication of complex geometries layer by layer, from digital blueprints. Traditionally confined to controlled environments like labs or factories, 3D printing is increasingly being explored in open outdoor settings for large-scale projects such as construction. The outdoor environment can introduce factors that can adversely affect the printing process such as internal and external factors.

Internal factors can include the microstructure of a target object and object quality. The microstructure of an object impacts its mechanical properties like ductility, hardness, and deformation resistance. Object quality can be dictated by the printer’s fidelity to the original digital blueprint, and it can be influenced by the printing speed, material deposition rate, and nozzle movement.

External factors like airflow, temperature, and humidity can significantly disrupt the 3D printing process. For example, airflow can cause the material to cool unevenly, leading to warping or deformation. Humidity can interfere with material bonding, and temperature changes can affect the consistency of the material being extruded.

While performing large 3D printing in external open area, there can be various types of challenges. There are various factors to consider such as microstructure, object quality, temperature, humidity, and so on. 3D printing can be disrupted by these factors which can potentially lead to defects. Thus, an AI-enabled system can be employed to maintain productivity by dynamically adjusting printing plans, configuration, and introducing protective layers to counter external factors, guaranteeing consistent quality. By doing so, efficient and high-quality production can be ensured.

The present embodiments can minimize the effects of internal factors (e.g., nozzle height, material temperature, microstructure of a target object, etc.) and external factors (e.g., airflow, temperature, humidity) to the printing process of a 3D printer by using an artificial intelligence enabled decision engine (AIDE) that can generate optimal commands to compensate for the internal and external factors.

Exemplary applications/uses to which the present invention can be applied include, but are not limited to: manufacturing of custom-made products, generation of prostheses in the medical field, construction of buildings, etc.

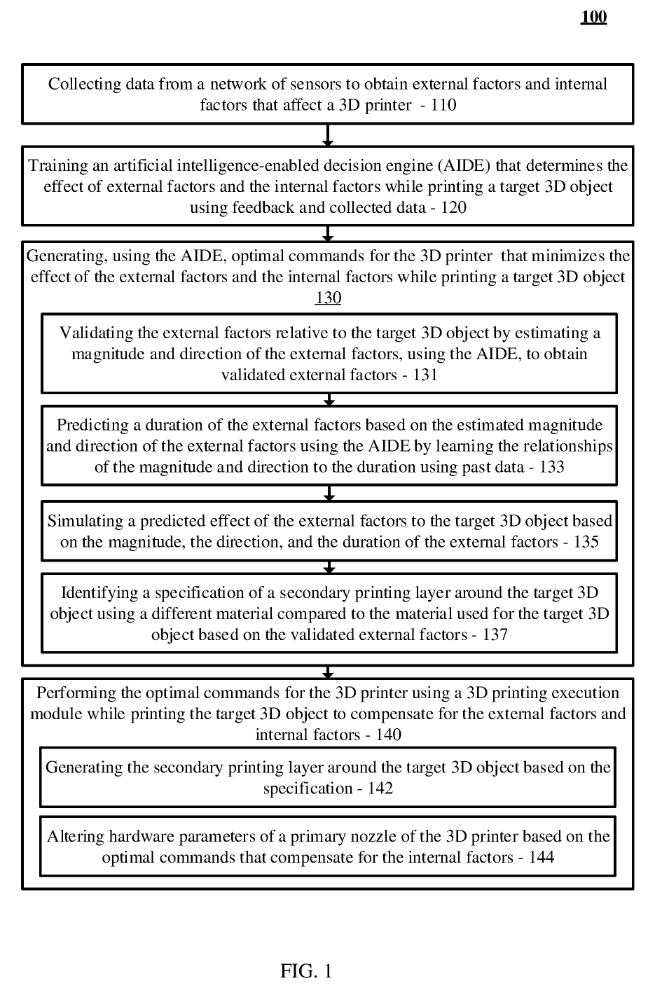

Referring now to the drawings in which like numerals represent the same or similar elements and initially to FIG. 1, showing a high-level overview of a computer-implemented method of managing 3D printers, in accordance with an embodiment of the present invention.

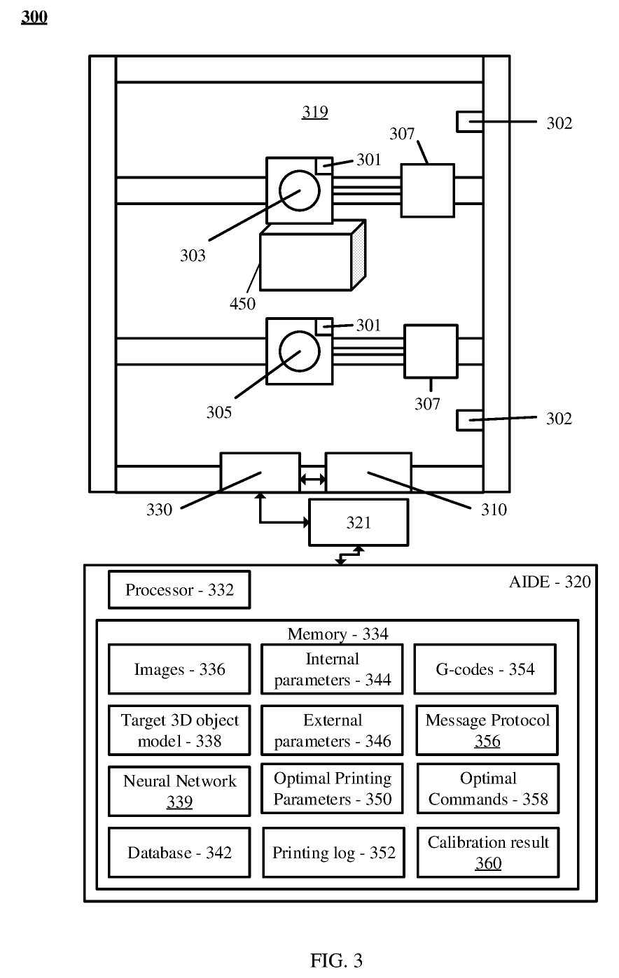

With the present embodiments, data from a network of sensors can be collected to obtain external factors and internal factors that affect a 3D printer. An artificial intelligence-enabled decision engine (AIDE) that determines an effect of the external factors and the internal factors while printing a target 3D object can be trained using feedback and collected data. Optimal commands for the 3D printer that minimizes the effect of external factors and the internal factors while printing a target 3D object can be generated using the AIDE. The optimal commands for the 3D printer can be performed using a 3D printing execution module while printing the target 3D object to compensate for the external factors and the internal factors. Note that the reference numbers can be found in FIG. 3.

In block 110, data from a network of sensors can be collected to obtain external factors and internal factors that affect a 3D printer.

The present embodiments can collect data regarding external and internal factors using a network of sensors (e.g., 301 and 302). The external factors can include environmental conditions (e.g., airflow speed, humidity, temperature, etc.). The internal factors can include internal parameters (e.g., nozzle movement, printing speed, material deposition rate, etc.) of the 3D printing system 300.

The network of sensors (e.g., 301 and 302) can include high-fidelity external sensors 302 for environmental variables such as anemometers for airflow speed, hygrometers for humidity, and thermometers for temperature. These sensors can be integrated into the 3D printer’s hardware. Additionally, internal 3D printer parameters like nozzle speed, deposition rate, and layer height can be monitored using embedded sensors 301. These internal factor data points can be preprocessed and streamed using a message protocol such as the message queuing telemetry transport (MQTT) protocol.

The network of sensors (e.g., 301 and 302) can be recalibrated based on feedback received from an AI-Enabled Decision Engine (AIDE) 320 that can utilize reinforcement learning (e.g., Q-Learning) to continually improve data accuracy and relevance. The network of sensors (e.g., 301 and 302) can include a feedback loop system that collects feedback from decision-making entities. The decision-making entity can be a pretrained AI model. In another embodiment, the decision-making entity can be a person. To retain previously learned knowledge, a database that contains the printing results of past printing processes can be employed and data from the database can be used as input for the AIDE 320. In another embodiment, a network of 3D printing systems 300 can share printing parameters and results of their printing objects.

Sensor data can be collected using native APIs provided by the sensor manufacturers such as IEEE™ 802.11 for wireless communication between the sensors and the AI engine, and ISO™/IEC™ 20547-5 for big data interoperability between the sensing module and the AI engine.

Before feeding the sensor data into the AIDE 320, the collected data can undergo preprocessing including outlier elimination using the Tukey method, and data normalization using min-max scaling. The Tukey method compares the statistical significance of the difference between means that have been selected for comparison because of their extreme values. The data preprocessing step ensures that the machine learning models are not misled by noisy or skewed data. The preprocessed data can then be streamed in real-time to the AI-Enabled Decision Engine (AIDE) 320 using a streaming method such as publish-subscribe pattern over the MQTT protocol.

In block 120, the AIDE that determines the effect of external factors and the internal factors while printing a target 3D object can be trained continuously using feedback and collected data.

The AIDE 320 employs an online learning algorithm that continuously updates the models based on the feedback received from the feedback mechanism about the 3D printing execution module 330. This allows the system to adapt to new conditions and improve over time.

The AI-enabled decision engine (AIDE) 320 can utilize neural networks 339 such as Long Short-Term Memory (LSTM) for time-series predictions and regression of data obtained from the network of sensors such as nozzle speed, deposition rate, movements, layer height, target 3D object specification, etc. The AIDE 320 can generate predictions of the effects of the internal factors and external factors to the 3D printing process. For example, the AIDE 320 can predict the temperature change of a currently printed object based on an increase of temperature by an average of 5 degrees Celsius and compare that to the optimal temperature limit for the material used for 3D printing.

Additionally, the AIDE 320 can utilize random forest to combine outputs of multiple decision trees generated from the feature-rich sensor data (e.g., temperature, humidity, airflow speed, viscosity of material, temperature of material, etc.) for immediate decision-making. For example, the AIDE 320 can generate multiple decision trees that include nodes referring to different 3D printing parameters, with corresponding predicted effect of the internal factors and the external factors. The decision trees can evaluate a subset of the feature-rich sensor data to decide on immediate actions. The output of the random forest can include probabilities of printer parameter adjustments as the optimal commands.

Further, the AIDE 320 can use weighted voting ensemble method to aggregate the decisions from different models based on each models’ historical accuracy. To compute the aggregate decisions from the models (e.g., LSTM, random forest, etc.), the sum of the product of the weight and the model predictions can be computed.

In block 130, optimal commands for the 3D printer can be generated using an artificial intelligence (AI) enabled decision engine that minimizes the effect of external factors and the internal factors while printing a target 3D object.

An event streaming platform such as Apache™ Kafka™ can be used for data ingestion and buffering. Command generation and dispatch to the 3D printing execution module 330 happen via Representational State Transfer Application Programming Interfaces (REST APIs).

To determine the optimal parameters, the AIDE 320 ingests real-time data from the network of sensors. The event streaming platform can buffer the incoming data to handle bursty workloads. Once ingested, feature engineering Principal Component Analysis (PCA) is applied to reduce the dimensionality of the data while retaining its important characteristics. A specification of a secondary printing layer can be determined using PCA.

Multiple machine learning models run in parallel to analyze the incoming data. This includes Random Forest for estimating the impact on microstructure, and LSTM networks for time-series prediction of environmental factors. A weighted voting ensemble method combines their outputs. In an embodiment, the decision trees for the random forest can be generated using reinforcement learning (e.g., Q-learning) to determine the optimal printing parameters 350 based on a determined effect of the internal and external factors to the 3D printing process. The optimal printing parameters 350 can include parameters learned to minimize material use and maximize structural integrity based on the input data. The optimal printing parameters 350 can be stored in a database 342.

To minimize the effects of the external and internal factors, the AIDE 320 can generate optimal commands 358 for adjusting the 3D printing process based on the learned optimal parameters of the AIDE 320. The optimal commands 358 can include adjustments to the nozzle speed, printing path, or even triggering the printing of a secondary protective layer separate from the currently printed object of the target 3D object model 338. The optimal commands 358 are then sent to the 3D printing execution module 330. The AIDE 320 can also use PCA, Random forest, LSTM, weighted voting ensemble method, reinforcement learning to generate the optimal commands 358 based on the learned optimal parameters, and the learned effects of the internal factors and the external factors to the 3D printing process. The optimal commands 358 can be stored in the database 342.

In block 131, while the 3D printing is in progress, the AIDE can validate how the external factors can affect the target 3D object being printed such as deformation or altering the microstructure formation pattern by estimating the magnitude and direction of the external forces based on the collected data by the external sensors.

After estimating the magnitude and direction of the external factors, the estimated magnitude and direction can be cross-validated with actual data collected by the external sensors 302.

Additionally, the AIDE 320 can also validate how the internal factors, such as nozzle speed, deposition rate, or layer height, etc., affect the target 3D object model 338 being printed based on the data continually received from the embedded sensors 301. After estimating the magnitude and direction of the internal factors, the estimated magnitude and direction can be cross-validated with actual data collected by the embedded sensors 301.

In block 133, the AIDE can predict the duration of the external factors based on the estimated magnitude and direction of the external factors by learning the relationships of the magnitude and direction to the duration using past data. Finite element analysis can be utilized to predict the duration of the external factors based on the estimated magnitude and direction of the external factors. A simulation can also be generated based on the predicted duration which can be presented in a printing log 352.

In block 135, the AIDE can simulate the predicted effects of the external factors to the target 3D object based on the magnitude and direction of the external factors. The simulation can include changes in shape, temperature, structural integrity of the currently printed object due to the predicted effect of the external factors and the internal factors. The simulation can be displayed to a decision-making entity for reference. The simulation can be included in a printing log 352. The AIDE 320 can predict the optimal parameters and corresponding optimal commands based on the simulation.

In block 137, the AIDE can identify a specification of a secondary printing layer around the target 3D object to allow the 3D printer to continue printing while minimizing the effect of the external factors to the target 3D object model 338 being printed. The specification can include the material to be used, dimensions of the secondary printing layer including height, width, length, distance from the currently printed object, etc. For example, in an enclosed setting where a hole increases airflow to the left of the currently printed object by a surface area with a five meter radius. A secondary printing layer can be generated to the left of the currently printed object to completely block the increased airflow affecting the currently printed object. The specification can be updated based on the direction, magnitude and duration of the external factors.

In block 140, the optimal commands for the 3D printer can be performed using a 3D printing execution module while printing the target 3D object.

The 3D printing execution module 330 can receive optimal commands 358 from the AIDE 320 via application program interfaces (APIs). The optimal commands 358 are then placed into a priority queue to ensure that urgent adjustments are executed first, such as adding a protective layer in extreme conditions.

The 3D printing process initiates by following the original blueprint for the target 3D object model 338. A low-latency feedback loop, including embedded sensors, with the AIDE 320 can confirm the progress of the 3D printing process and provides real-time updates.

In block 142, a second nozzle can activate to print a protective layer around the primary object based on the specification determined by the AIDE. The material for this layer is chosen based on the environmental factors as determined by the AIDE.

In block 144, based on the optimal commands, the 3D printing execution module 330 can dynamically alter the hardware parameters of the primary nozzle of the 3D printer such as nozzle speed, deposition rate, or layer height according to the received instructions. Embedded sensors 301 in the module constantly monitor the status of the print, such as layer bonding and structural integrity. This data is sent back to the AIDE 320 for further refinement of future actions.

The AIDE 320 can determine that conditions for printing the target 3D object model 338 are too unfavorable due to the effect of internal factors or external factors based on the validated external and internal factors (e.g., magnitude, direction, duration, etc.) compared to a limit threshold. The limit threshold can be predefined based on the external or internal factors and the materials used for 3D printing and stored in the database 342. For example, material X used in 3D printing has a limit of 250 degrees Celsius, then the limit threshold for the internal factor (e.g., material temperature, nozzle temperature, etc.) for material X can be 250 degrees Celsius. Once the limit threshold is met and the AIDE cannot cool the temperature of material X used in the printing process by updating the configuration (e.g., hardware parameters) of the 3D printing system 300, the AIDE 320 can generate g-codes 354 to terminate or pause the 3D printing process to cool material X down to the optimal temperature. The AIDE 320 can send a status update indicating the reason for halting, allowing for post-mortem analysis through a printing log 352.

The present embodiments can minimize the effects of internal factors (e.g., nozzle height, material temperature, microstructure of a target object, etc.) and external factors (e.g., airflow, temperature, humidity) to the printing process of a 3D printing system 300 by using an artificial intelligence enabled decision engine (AIDE) 320 that generates optimal commands to compensate for the internal and external factors.

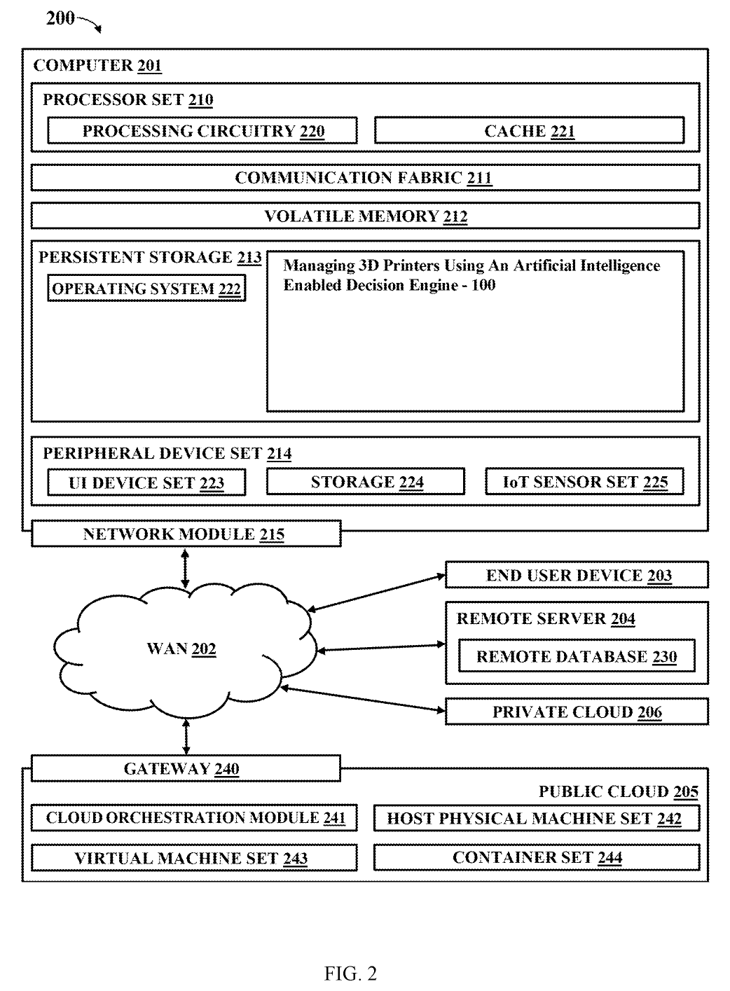

Referring now to FIG. 2, showing a system for managing 3D printers, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 contains an example of an environment for the execution of at least some of the computer code involved in performing the inventive methods, such as managing 3D printers using an artificial intelligence enabled decision engine 100. In addition to block 100, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and block 100, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

COMPUTER 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible.

Computer 201 may be located in a cloud, even though it is not shown in a cloud in FIG. 2. On the other hand, computer 201 is not required to be in a cloud except to any extent as may be affirmatively indicated.

PROCESSOR SET 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a

series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in block 100 in persistent storage 213.

COMMUNICATION FABRIC 211 is the signal conduction path that allows the various components of computer 201 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

PERSISTENT STORAGE 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices.

Operating system 222 may take several forms, such as various known proprietary operating systems or open source Portable Operating System Interface-type operating systems that employ a kernel. The code included in block 100 typically includes at least some of the computer code involved in performing the inventive methods.

PERIPHERAL DEVICE SET 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

NETWORK MODULE 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

REMOTE SERVER 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

PUBLIC CLOUD 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

Referring now to FIG. 3, showing a 3D printing system, in accordance with an embodiment of the present invention.

3D printing system 300 can include a network of sensors further including external sensors 302 and embedded sensors 301. 3D printing system 300 can include an 3D printing execution module 330, calibration system 321, configuration system 310, material reservoir 307, primary nozzle 303 and secondary nozzle 305, and printing platform 319. The 3D printing system 300 can capture images 336 of the target 3D object to generate a target 3D object model 338 for 3D printing.

The external sensors 302 can collect data regarding the external factors (e.g., temperature, airflow, humidity, etc. which is included in the collected external parameters 346). The embedded sensors 301 can collect data regarding the internal factors (included in the collected internal parameters 344). The configuration system 310 can contain the current parameters of the primary nozzle 303, secondary nozzle 305 and material reservoir 307, and configurations of the 3D printing system 300 to print the target 3D object model 338. The configuration system 310 can include nozzle speed, layer height, material temperature, etc. The calibration system 321 can receive the calibration result 360 from the AIDE 320 to calibrate the 3D printer 300 and update the configuration system 310 and the 3D printing execution module 330 based on the optimal commands 358 that can include optimal printing parameters 350.

The AIDE 320 can include a processor 332 operatively coupled with a memory 334 to perform the operations described herein. The AIDE 320, by utilizing neural network 339, can determine the optimal commands 358 that can minimize the effect of internal factors (included in the collected internal parameters 344) and external factors (included in the collected external parameters 346) on the printing process of the target 3D object model 338. The neural network 339 can implement LSTM, random forest, reinforcement learning, etc. The AIDE 320, by utilizing neural network 339, can continuously determine the optimal commands 358 in real time and can dynamically adjust the configuration of the 3D printing system 300 through the configuration system 310 based on the ingested data from the network of sensors (e.g., embedded sensors 301 and external sensors 302). The AIDE 320 can process, receive, and generate codes compliant with a message protocol 356 to receive and process data from the network of sensors (e.g., 301 and 302).

The 3D printing execution module 330 can perform the optimal commands 358 determined by the AIDE 320. The optimal commands 358 can include calibration result 360 such as adjusting the internal parameters 344 of the configuration through the configuration system 310 of the 3D printing system 300 such as increasing nozzle speed, increasing layer height, lowering material temperature, etc. The optimal commands 358 can include the g-codes 354 that commands the 3D printing execution module 330 to 3D print the target 3D object model 338. The g-codes 354 can include commands to terminate, pause, speed up, etc., the 3D printing process based on the determine optimal commands 358. For example, if the AIDE 320 determines that the 3D printing process cannot continue due to the external factors and internal factors, the AIDE 320 can generate optimal commands include g-codes 354 to terminate or pause the 3D printing process.

The AIDE 320 can include a database 342 that stores the optimal printing parameters 350, internal parameters 344, external parameters 346, images 336, printing log 352, g-codes 354, optimal commands 358, and the calibration result 360. The database 342 can store relevant data for the optimal printing parameters such as material information, printing plans for a particular model, etc.

The printing log 352 can include information about the progress of the 3D printing such as detected internal factors, external factors, corresponding optimal printing parameters 350 for the internal factors and external factors, calibration result 360. The printing log 352 can include simulations of the predicted effect of the internal factors and external factors to a currently printed object including the duration, magnitude and direction of such factors. The printing log 352 can be displayed to a decision-making entity.

The material reservoir 307 can store and provide the material needed to print the target 3D object model 338. The material reservoir 307 can also store and provide secondary material needed to print a secondary printing layer to minimize the effect of external factors to the printing of the target 3D object model 338.

After the 3D printing process is completed, the assembled 3D object 450 is verified through the calibration system 321, the configuration system 310, and the AIDE 320 to determine and remove excess material used to 3D print the target 3D object model 338. The specification of the target 3D object such as shape constraints, load capacity, material consistency, etc. are verified by the calibration system 321, the configuration system 310, and the AIDE 320. The calibration system 321 can include vision detection models such as convolutional neural networks, vision transformers, to detect the inconsistencies with the printed target 3D object model 338 and generate a calibration result 360 based on the detected inconsistencies.

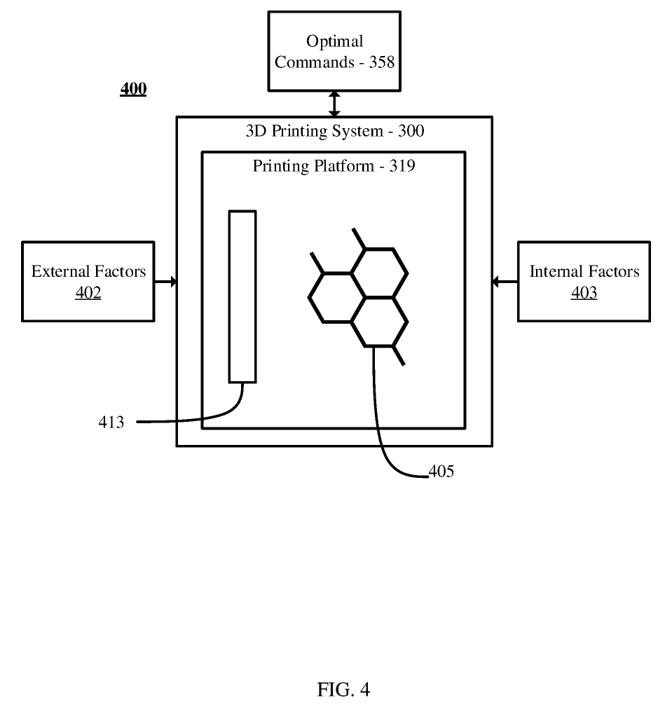

Referring now to FIG. 4, showing a system that manages 3D printers using the AI-enabled decision engine, in accordance with an embodiment of the present invention.

In system 400, a target 3D object 405 is being printed by 3D printing system 300. Internal factors 403 and external factors 402 can affect the 3D printing system 300. The 3D printing system 300 can generate optimal commands 358 to minimize and compensate for the effect of the internal factors 403 and external 402 such as updating the hardware configuration of the 3D printing system 300 (e.g., increasing nozzle speed, increasing material temperature, etc.), generating secondary printing layer 413, generating g-codes 354 to terminate, pause, speed up, slow down, the 3D printing process, etc.

The secondary printing layer 413 can block and minimize the effects the external factors 402 to the target 3D object 405. The secondary printing layer 413 and the target 3D object 405 can be printed on the printing platform 319.

The present embodiments can also be applied to manufacturing of custom-made products, generation of prosthesis in the medical field, construction of buildings, generating large component fabrication for aerospace engineering, vehicle frame generation for automotive manufacturing, hull construction for marine engineering, etc. In another embodiment, the present embodiments can perform four dimensional (4D) printing by using materials that react to environmental stimulus and change over time.

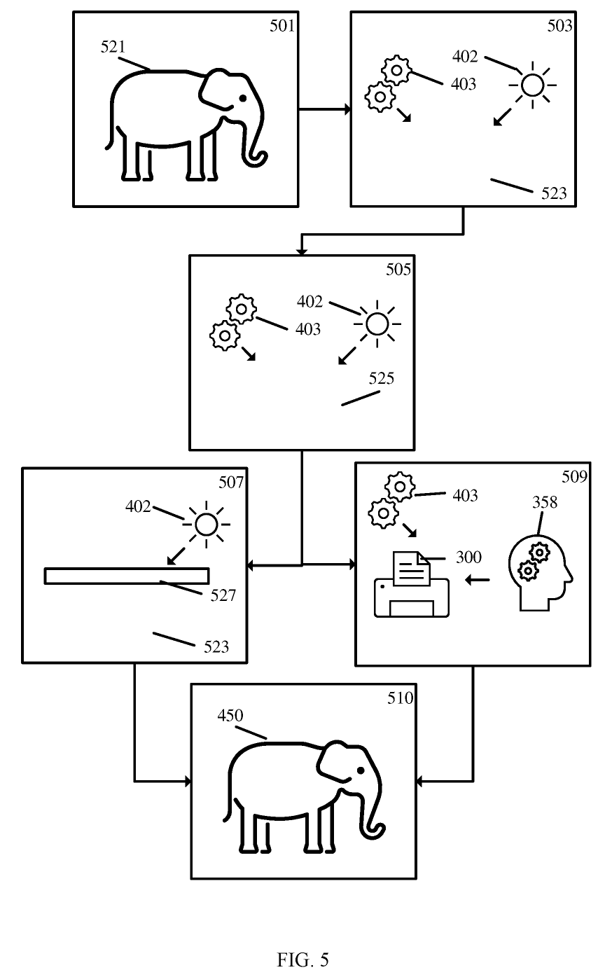

Referring now to FIG. 5, showing a block diagram of the operations employed to generate optimal commands, in accordance with an embodiment of the present invention.

In block 501, the target 3D object 501 is processed to generate target 3D object model 338. The target 3D object model 338 can include the specification of the materials to be used, a 3D mesh model of the target 3D object 501, etc.

In block 503, the current printed object 523 can be affected by internal factors 403 and external factors 402. The AIDE 320 can verify the external factors 402 by estimating the intensity, direction, and duration of the external factors 402. The AIDE can also verify the internal factors 403 by estimating the intensity, direction, and duration of the internal factors 403. The verification of the internal factors 403 and external factors 402 can be shown in a simulation.

In block 505, a simulated printed object 525 can be simulated by the AIDE 320 to simulate the effects of the internal factors 403 and external factors 402. For example, the external factors 402 can include heat, airflow, etc., which can affect the temperature of the material being deposited through the 3D printing process which can make the current printed object 523 shrink, expand, crack, warp, etc. The simulations including the simulated printed object 525 can be shown to a decision-making entity.

In block 507, a secondary printing layer 527 can be printed to protect the current printed object 523 from the effects of the external factors 402. The secondary printing layer 527 can be updated depending on the duration, intensity, and direction of the external factors. For example, if the external factors (e.g., airflow) is detected coming from the left side of the current printed object 523, then the secondary printing layer 527 is generated on the left side of the current printed object. If the external factor changed directions from the left side to the right side of the current printed object 523, another secondary printing layer 527 can be generated on the right side of the current printed object.

The material used for the secondary printing layer 527 can be a different material from the material used for the current printed object 523. For example, mud, cement, etc., can be used as the material for the secondary printing layer 527.

In block 509, optimal commands 358 can be generated to compensate for the effects of the internal factors 403 to the 3D printing system 300 based on its simulated effect on the current printed object 523 as shown in simulated printed object 525. For example, the nozzle height can affect the amount of material deposited while 3D printing. Due to the excessive amount of material deposited, the current printed object 523 is determined and simulated to become warped. The AIDE 320 can generate optimal commands 358 to lower the nozzle height and correct the amount of material deposited while 3D printing.

In block 510, the 3D printing process is completed with the assembled 3D object 450 which is compliant with the intended specification of the target 3D object model 338.

An artificial neural network (ANN) is an information processing system that is inspired by biological nervous systems, such as the brain. One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

In an embodiment, the AIDE 330 can be trained to determine optimal printing parameters 350 for the 3D printing system 300 based on the collected data that includes the external factors and internal factors and how they affect the printing process of the target 3D object. The AIDE 330 can also be trained to determine and generate optimal commands 358 based on the optimal printing parameters 350 by utilizing random forests, LSTM and weighted voting ensemble methods to aggregate the decisions from the different models.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights may be implemented as resistive processing units (RPUs), generating a predictable current output when an input voltage is applied in accordance with a settable resistance.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method, comprising:
collecting data from a network of sensors to obtain external factors and internal factors that affect a 3D printer;
training an artificial intelligence-enabled decision engine (AIDE) that determines an effect of external factors and the internal factors while printing a target 3D object using feedback and collected data;
generating, using the AIDE, optimal commands for the 3D printer that minimizes an effect of external factors and the internal factors while printing a target 3D object; and
performing the optimal commands for the 3D printer using a 3D printing execution module while printing the target 3D object to compensate for the external factors and internal factors.

2. The computer-implemented method of claim 1, wherein generating the optimal commands further comprises validating the external factors relative to the target 3D object by estimating a magnitude and direction of the external factors to obtain validated external factors.

3. The computer-implemented method of claim 2, wherein generating the optimal commands further comprises predicting a duration of the external factors based on the estimated magnitude and direction of the external factors using the AIDE.

4. The computer-implemented method of claim 3, wherein generating the optimal commands further comprises simulating a predicted effect of the external factors to the target 3D object based on the magnitude, the direction, and the duration of the external factors.

5. The computer-implemented method of claim 2, wherein generating the optimal commands further comprises identifying a specification of a secondary printing layer around the target 3D object using a different material compared to the material used for the target 3D object based on the validated external factors.

6. The computer-implemented method of claim 5, wherein performing the optimal commands further comprises generating the secondary printing layer around the target 3D object based on the specification.

7. The computer-implemented method of claim 1, wherein performing the optimal commands further comprises altering hardware parameters of a primary nozzle of the 3D printer based on the optimal commands.

8. The computer-implemented method of claim 1, wherein performing the optimal commands further comprises terminating the printing of the target 3D object based on an identified effect of the external factors to the printing of the target 3D object.

9. A computer system, comprising:
a processor set;
one or more computer-readable storage media; and
program instructions stored on the one or more computer-readable storage media to cause the processor set to perform operations comprising:
collecting data from a network of sensors to obtain external factors and internal factors that affect a 3D printer;
training an artificial intelligence-enabled decision engine (AIDE) that determines an effect of external factors and the internal factors while printing a target 3D object using feedback and collected data;
generating, using the AIDE, optimal commands for the 3D printer that minimizes an effect of external factors and the internal factors while printing a target 3D object; and
performing the optimal commands for the 3D printer using a 3D printing execution module while printing the target 3D object to compensate for the external factors and internal factors.

10. The computer system of claim 9, wherein the 3D printer further includes a primary nozzle to print the target 3D object.

11. The computer system of claim 9, wherein the 3D printer further includes a secondary nozzle to print a secondary printing layer to minimize the effect of external factors to the target 3D object.

12. The computer system of claim 9, wherein the network of sensors further includes embedded sensors and external sensors for the 3D printer.

13. A computer program product, comprising:
one or more computer-readable storage media; and
program instructions stored on the one or more computer-readable storage media to perform operations comprising:
collecting data from a network of sensors to obtain external factors and internal factors that affect a 3D printer;
training an artificial intelligence-enabled decision engine (AIDE) that determines an effect of external factors and the internal factors while printing a target 3D object using feedback and collected data;
generating, using the AIDE, optimal commands for the 3D printer that minimizes an effect of external factors and the internal factors while printing a target 3D object; and
performing the optimal commands for the 3D printer using a 3D printing execution module while printing the target 3D object to compensate for the external factors and internal factors.

14. The computer program product of claim 13, wherein generating the optimal commands further comprises validating the external factors relative to the target 3D object by estimating a magnitude and direction of the external factors to obtain validated external factors.

15. The computer program product of claim 14, wherein generating the optimal commands further comprises predicting a duration of the external factors based on the estimated magnitude and direction of the external factors using the AIDE.

16. The computer program product of claim 15, wherein generating the optimal commands further comprises simulating a predicted effect of the external factors to the target 3D object based on the magnitude, the direction, and the duration of the external factors.

17. The computer program product of claim 14, wherein generating the optimal commands further comprises identifying a specification of a secondary printing layer around the target 3D object using a different material compared to the material used for the target 3D object based on the validated external factors.

18. The computer program product of claim 17, wherein performing the optimal commands further comprises generating the secondary printing layer around the target 3D object based on the specification.

19. The computer program product of claim 13, wherein performing the optimal commands further comprises altering hardware parameters of a primary nozzle of the 3D printer based on the optimal commands.

20. The computer program product of claim 13, wherein performing the optimal commands further comprises terminating the printing of the target 3D object based on an identified effect of the external factors to the printing of the target 3D object.
